(19) United States
(12) Patent Application Publication
(10) Pub. No.: US 2017/0245319 A1
(43) Pub. Date: Aug. 24, 2017

(54) USER APPARATUS, BASE STATION, AND DISCONTINUOUS RECEPTION METHOD

(71) Applicant: NTT DOCOMO, INC., Tokyo (JP)

(72) Inventors: Shimpei Yasukawa, Tokyo (JP); Hiroki Harada, Tokyo (JP); Satoshi Nagata, Tokyo (JP)

(73) Assignee: NTT DOCOMO, INC., Tokyo (JP)

(21) Appl. No.: 15/518,815

(22) PCT Filed: Oct. 14, 2015
(86) PCT No.: PCT/JP2015/079077

§ 371 Date: Apr. 13, 2017

(30) Foreign Application Priority Data
Oct. 17, 2014 (JP) 2014-213221

(51) Int. Cl. H04W 76/04; H04W 52/02

(52) U.S. Cl. CPC H04W 76/048; H04W 52/028; H04W 52/0248; H04W 52/0229; H04W 92/18

(57) ABSTRACT

A user apparatus is provided. The user apparatus is used in a mobile communication system supporting Device-to-Device (D2D) communications. The user apparatus includes a control unit configured to put the user apparatus in a discontinuous reception state in the case where predetermined time elapses after the time when a predetermined D2D signal has been last received, and a reception unit configured to monitor D2D resources arriving at a predetermined period in the discontinuous reception state.

### BACKGROUND OF THE INVENTION

1. Field of the Invention

The present invention relates to D2D communications (Device to Device communications), and, in particular, relates to a technique in which a user apparatus UE performs discontinuous reception (DRX) in the D2D communications.

2. Description of the Related Art

In general, communications between user apparatuses UEs are performed by having each of the user apparatuses UEs communicating with a base station eNB in a mobile communication system such as a current Long Term Evolution (LTE) system. In recent years, however, various techniques related to D2D communications (hereinafter referred to as “D2D”) are proposed in which the user apparatuses UEs directly perform communications.

In particular, in the LTE D2D communications, “communication” and “discovery” are proposed. In the “communication”, the user apparatuses UEs perform data communications such as push communications. In the “discovery”, a transmission side user apparatus UE transmits a discovery signal including an ID of the user apparatus UE and an application ID, and causes a reception side user apparatus UE to detect the transmission side user apparatus UE (refer to NPL

In the D2D defined in LTE, it is proposed that a user apparatus UE uses a part of uplink resources predefined as resources for uplink signal transmission from the user apparatus UE to a base station eNB. Further, regarding allocating resources used for the D2D, it is also proposed that the base station eNB provides assistance. In the following, an overview of resource allocation currently proposed in the LTE D2D will be described (refer to NPL 1).

Regarding the “discovery”, as illustrated in FIG. 1A, a resource pool for discovery signals is reserved in each discovery period, and a user apparatus UE transmits a discovery signal in the resource pool. More specifically, there are Type 1, Type 2a, and Type 2b. In Type 1, the user apparatus UE autonomously selects a transmission resource from the resource pool. In Type 2a, the transmission resource is allocated by (E)PDCCH. In Type 2b, a more semi-static transmission resource is allocated by upper layer signaling (e.g., RRC signal).

Regarding the “communication”, as illustrated in FIG. 1B, it is also assumed that resources for SA/data transmission are periodically reserved. SA is an acronym of Scheduling Assignment. A transmission side user apparatus UE reports resources for data transmission to a reception side user apparatus UE by using a resource selected from the SA resource pool, and transmits data via the resource for data transmission. A signal for reporting the resource may be referred to as an SA or a SA signal. More specifically, there are Mode 1 and Mode 2 in the “communication”. In Mode 1, resources are allocated more dynamically by (E)PDCCH transmitted from a base station eNB to a user apparatus UE. Further, in the allocation by (E)PDCCH, a semi-static resource allocation (SPS: Semi-persistent scheduling) is also proposed. In Mode 2, a user apparatus UE autonomously selects a transmission resource from the SA resource pool.

FIG. 1C illustrates more specifically an example in which the D2D resource pool and WAN resources are multiplexed by FDM/TDM. In FIG. 1C, a D2D Synchronization Signal (D2DSS)/Physical D2D Synchronization Channel (PD2DSCH) is also illustrated, which is transmitted periodically.

### CITATION LIST

### Non-Patent Literature

[NPL 1] 3GPP TR36.843 V12.0.1 (2014-03)

### SUMMARY OF THE INVENTION

### Technical Problem

As described above, in D2D communications, a reception side user apparatus UE detects data by monitoring an SA. In the SA, an ID is included which is used for determining whether the user apparatus UE should receive the SA. It is possible for the user apparatus UE to perform SA reception filtering based on the ID.

However, in order to meet VoIP requirements, resources are frequently set for an SA, and there is a problem in that battery energy consumption of a user apparatus UE is increased because the user apparatus UE monitors the SA all the time.

Therefore, there is an idea in which discontinuous reception (DRX) is performed in the D2D communications in order to save the battery energy consumption. Currently, however, DRX is not defined in the D2D communications. Conventionally, DRX is not performed in the D2D communications. It should be noted that there exists a problem illustrated in FIG. 2 and FIG. 3 when terminal-implemented DRX is performed.

In an example illustrated in FIG. 2, a UE-A transmits an SA to a UE-B in a DRX state. The transmission side UE-A periodically transmits an SA at a predetermined period. However, the UE-B performs reception at a low frequency (long intervals) because the UE-B is in a DRX state. Therefore, it is expected that a great amount of delay may occur because the UE-B in a DRX state fails to receive the SA normally due to a mismatch between the transmission resources and the reception.

In FIG. 3, it is assumed that VoIP communications are performed. As illustrated in the figure, the UE-B in a DRX state does not receive the first upper layer control information, a header, etc. Afterwards, as a result, the UE-B cannot decode voice data even if an SA is received. In other words, similarly, there is a possibility that the SA reception in the middle of communications may also create a great amount of delay.

It should be noted that a problem such as increased battery energy consumption as described above occurs not only in the SA, but also in D2D signals in general.

The present invention has been made in view of the above. It is an object of the present invention to provide a technique which enables a user apparatus to perform discontinuous reception operations appropriately.

### Solution to Problem

According to an embodiment of the present invention, a user apparatus is provided. The user apparatus is used in a mobile communication system that supports D2D communications. The user apparatus includes a control unit configured to put the user apparatus in a discontinuous reception state in the case where predetermined time elapses after a predetermined D2D signal has been last received, and a reception unit configured to monitor a D2D resource arriving at a predetermined period in the discontinuous reception state.

Further, according to an embodiment of the present invention, a discontinuous reception method is provided. The discontinuous reception method is used in a mobile communication system that supports D2D communications. The discontinuous reception method includes putting the user apparatus in a discontinuous reception state in the case where predetermined time elapses after a predetermined D2D signal has been last received, and monitoring a D2D resource arriving at a predetermined period in the discontinuous reception state.

### Advantageous Effects of Invention

According to an embodiment of the present invention, it is possible for a user apparatus to perform discontinuous reception operations appropriately.

### BRIEF DESCRIPTION OF THE DRAWINGS

FIG. 1A is a drawing illustrating D2D communications.

FIG. 1B is a drawing illustrating D2D communications.

FIG. 1C is a drawing illustrating D2D communications.

FIG. 2 is a drawing illustrating a problem.

FIG. 3 is a drawing illustrating a problem.

FIG. 4 is a diagram of a system according to an embodiment of the present invention.

FIG. 5 is a drawing illustrating basic operations of a user apparatus UE according to a first embodiment.

FIG. 6 is a drawing illustrating an example of a signaling sequence of D2D discontinuous reception setting information.

FIG. 7 is a drawing illustrating an operation example 1 of the user apparatus UE according to the first embodiment.

FIG. 8 is a drawing illustrating an operation example 2 of the user apparatus UE according to the first embodiment.

FIG. 9 is a drawing illustrating an operation example 3 of the user apparatus UE according to the first embodiment.

FIG. 10 is a drawing illustrating an overview of a second embodiment.

FIG. 11 is a drawing illustrating a sequence example according to the second embodiment.

FIG. 12 is a drawing illustrating a sequence example according to the second embodiment.

FIG. 13 is a drawing illustrating a sequence example according to the second embodiment.

FIG. 14 is a drawing illustrating an overview of a third embodiment.

FIG. 15 is a drawing illustrating an operation example 1 of the user apparatus UE according to the third embodiment.

FIG. 16 is a drawing illustrating an operation example 2 of the user apparatus UE according to the third embodiment.

FIG. 17A is a drawing illustrating an example of Response resources.

FIG. 17B is a drawing illustrating an example of Response resources.

FIG. 18 is a configuration diagram of the user apparatus UE.

FIG. 19 is a configuration diagram of the user apparatus UE.

FIG. 20 is a configuration diagram of the user apparatus UE.

FIG. 21 is a configuration diagram of a base station eNB.

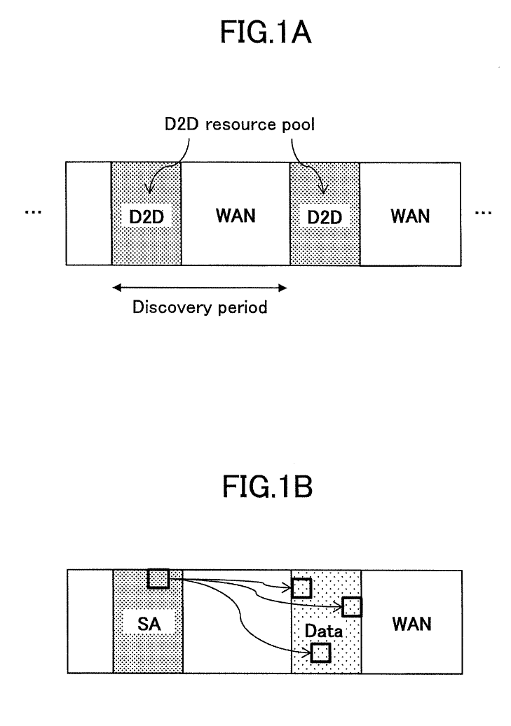

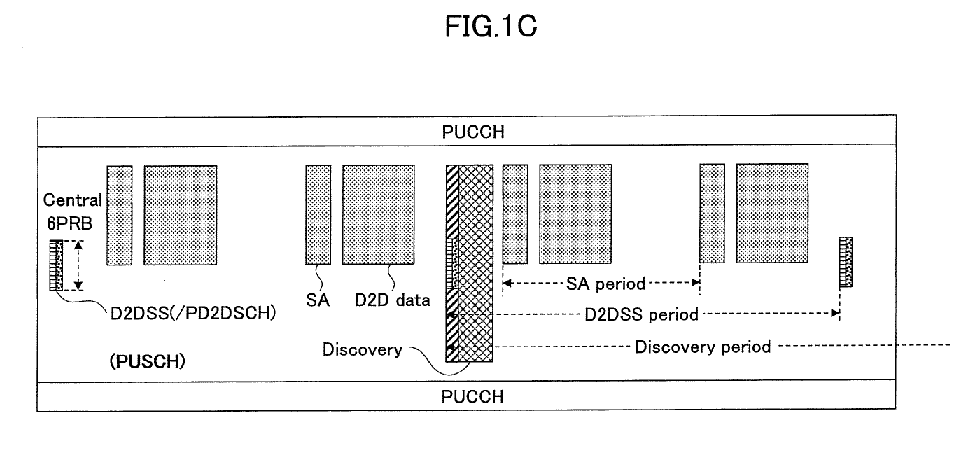

### DETAILED DESCRIPTION OF THE PREFERRED EMBODIMENTS

In the following, referring to the drawings, embodiments of the present invention will be described. The embodiments described below are merely examples and embodiments to which the present invention is applied are not limited to the following embodiments. For example, it is assumed that a mobile communication system according to an embodiment complies with LTE standards. However, it is not only LTE that the present invention can be applied to, but it is also other schemes that the present invention can be applied to. Further, in the following, the SA discontinuous reception is mainly described. However, a discontinuous reception technique according to an embodiment can be applied not only to the SA but also to D2D signals in general. It should be noted that, in the application specification and claims, the term “LTE” may be used in a broader sense, not only for meaning a communication method corresponding to 3GPP release 8 or 9, but also for meaning a communication method corresponding to 3GPP release 10, 11, 12, 13, or later.

(System Configuration)

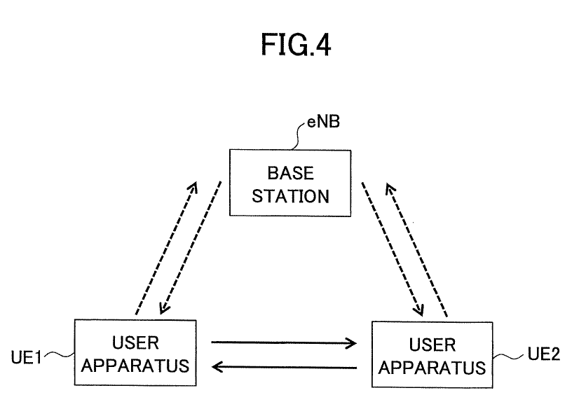

FIG. 4 is a drawing illustrating a configuration example of a communication system according to an embodiment of the present invention (common to all embodiments). As illustrated in FIG. 4, the communication system is a cellular communication system in which user apparatuses UE1 and UE2 exist under control of a base station eNB. Each of the user apparatuses UE1 and UE2 has a D2D communication function, and D2D communications can be performed between the user apparatuses UE1 and UE2. Further, it is possible for each of the user apparatuses UE1 and UE2 to perform normal cellular communications with a base station eNB, and to receive resource allocation for D2D communications from the base station eNB.

It is illustrated in FIG. 4 that the user apparatuses UE1 and UE2 are within a coverage of the base station eNB, which is just an example. The present invention can be also applied to a case in which a user apparatus UE is out of the coverage of the base station eNB. In the following, the user apparatuses UE1 and UE2 are collectively referred to as the user apparatus UE. Further, in the following, the user apparatus UE may be referred to as UE.

In the following, a first embodiment to a third embodiment will be described. It is possible for any two or three of the first embodiment to the third embodiment to be combined.

### First Embodiment

According to the first embodiment, a user apparatus UE performs discontinuous reception operations for a D2D signal (D2D channel). In an embodiment, a target of the discontinuous reception operations is an SA. The user apparatus UE receives data accompanying the SA only when the reception target SA is detected. Here, “discontinuous reception operations” refer to monitoring SA resources (all or a part of resource pools) at a predetermined time interval. “Monitoring” refers to receiving, demodulating, and decoding a signal of target resources, and to checking, for example, whether a detection target ID is included in the SA.

By performing the above described discontinuous reception operations, it is possible for the user apparatus UE to reduce its battery energy consumption. Further, by performing the discontinuous reception operations, opportunities of D2D communications decrease at the user apparatus UE. Therefore, in the case of a user apparatus UE incapable of simultaneously performing the D2D communications and WAN communications, opportunities of WAN reception will be increased.

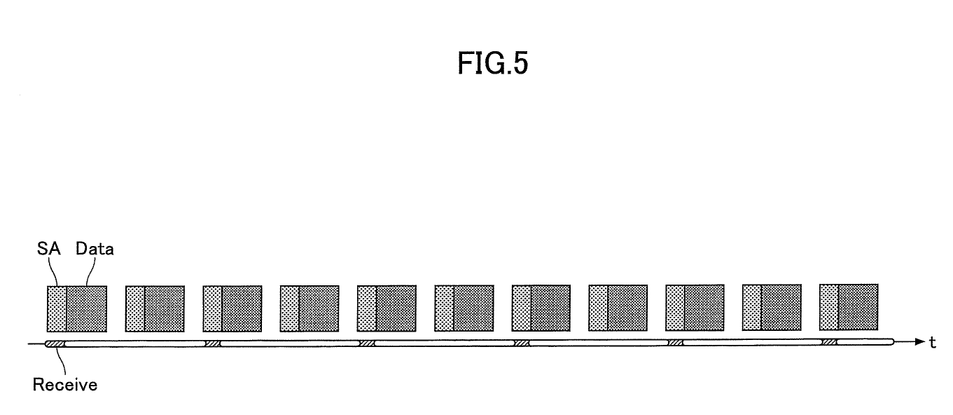

An example of a basic operation of the user apparatus UE according to an embodiment is illustrated in FIG. 5. In an example illustrated in FIG. 5, a predetermined period is defined. The user apparatus UE retains the period as setting information, and performs SA discontinuous reception operations at the predetermined period. In the following, more specific contents of the discontinuous reception operations will be described.

<Monitor Target Resources in Discontinuous Reception Operations>

As described above, the user apparatus UE in a discontinuous reception state monitors for SAs periodically. In the case where an SA resource pool arrives periodically, it is assumed that a discontinuous reception period is, for example, a constant multiple of a period of the SA resource pool. For example, in the case where the arriving period of the SA resource pool is P (ms), the discontinuous reception period is K*P (ms) (K is an integer equal to or greater than 2).

The above period may be preset in the user apparatus UE, or multiple periods are set in advance in the user apparatus UE and one of the periods may be selected autonomously. Further, a transmission side user apparatus UE may report the period to a reception side user apparatus UE by using a predetermined channel (e.g., PD2DSCH). Further, in the case where the user apparatus UE is in a coverage of the base station eNB, the period may be reported from the base station eNB to the user apparatus UE via upper layer signaling (RRC signaling, SIB, etc.).

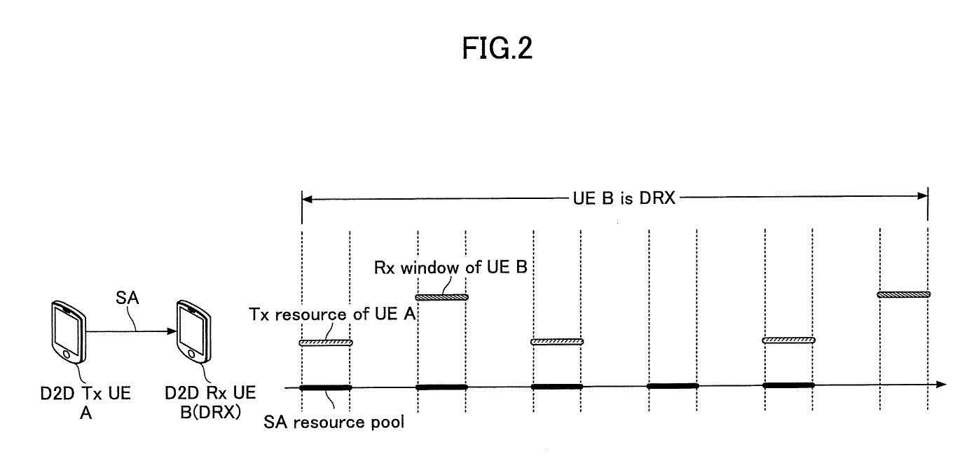

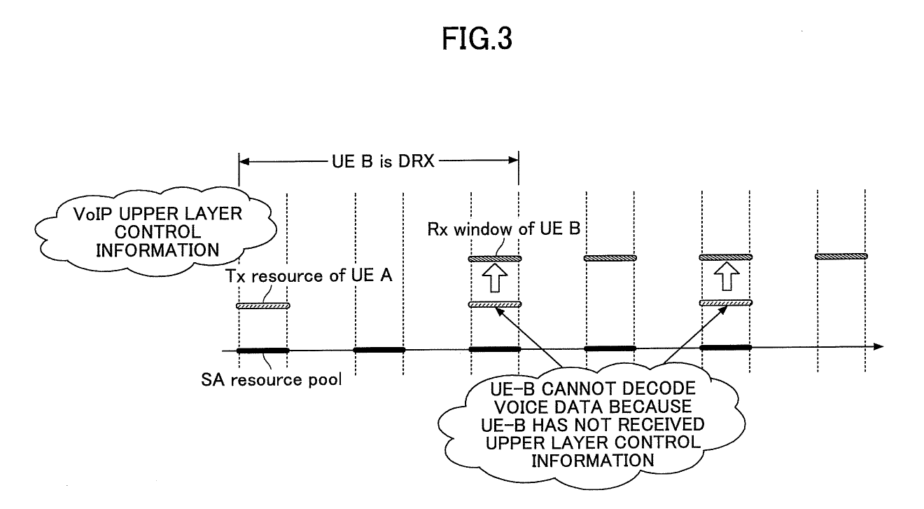

By performing the discontinuous reception operations, it is possible for the reception side UE to save the battery energy. Further, by defining the monitor target resources appropriately, it is also possible to resolve the problem such as a packet loss illustrated in FIG. 2 and FIG. 3. According to an embodiment, as an example, a “special SA region” is defined and discontinuous reception resources (e.g., subframes) are used, which discontinuous reception resources are recognized in common between the transmission side UE and the reception side UE, which will be described later.

<Trigger of Discontinuous Reception Operation>

An example of a trigger causing the user apparatus UE to enter into the discontinuous reception operation will be described. According to an embodiment, for example, the user apparatus UE starts the discontinuous reception operation when elapsed time (e.g., the number of elapsed resource pools, the number of elapsed frames), after last reception of an SA by the user apparatus UE in a continuous reception state, becomes equal to or greater than a predetermined value. The continuous reception state refers to a normal reception state in which, for example, the user apparatus UE monitors the SA resource pools at a period assigned to the user apparatus UE. The discontinuous reception operation may be performed for each SA resource pool. In other words, there may be an independent discontinuous reception operation trigger for each resource pool.

The SA assumed as a target of the last SA reception may be all SAs detected by the user apparatus UE, or may be an SA of interest by which the user apparatus UE receives data. Upon receiving the target SA described above, the user apparatus UE stops the discontinuous reception operation and transitions to the continuous reception state.

The above-described predetermined value may be preset in the user apparatus UE, or multiple values are set in advance in the user apparatus UE and one of the values may be selected autonomously. Further, a transmission side user apparatus UE may report the predetermined value to a reception side user apparatus UE by using a predetermined channel (e.g., PD2DSCH). Further, in the case where the user apparatus UE is in a coverage of the base station eNB, the predetermined value may be reported from the base station eNB to the user apparatus UE via upper layer signaling (RRC signaling, SIB, etc.).

Further, according to an embodiment, it is also possible to switch the UE performing the discontinuous reception operation to a continuous reception state by using wake-up signaling transmitted to the reception side UE from the base station eNB or the transmission side UE. The wake-up signaling will be described in detail together with a second embodiment.

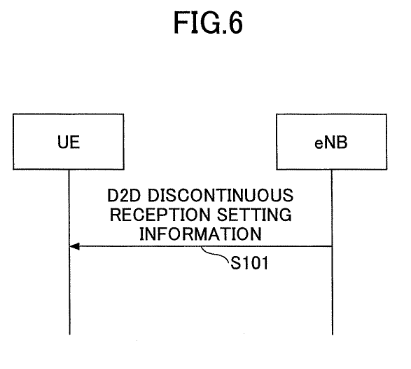

FIG. 6 illustrates an example of a signaling sequence in the case where the user apparatus UE is in a coverage of the base station eNB. The signaling is used for reporting D2D discontinuous reception setting information such as a period or a predetermined value (timer value used for transitioning to a continuous reception state) described above. As illustrated in FIG. 6, the D2D discontinuous reception setting information is transmitted from the base station eNB to the user apparatus UE via RRC, SIB, etc. The D2D discontinuous reception setting information is not limited to the above-described period or the predetermined value. For example, the D2D discontinuous reception setting information may be setting information for turning ON/OFF the discontinuous reception function of the UE.

<Special SA Region>

Next, the above-described special SA region will be described in detail.

As described above, the special SA region is defined in common between the transmission UE and the reception UE. It is defined that all of the user apparatuses UEs monitor for SAs in the special SA region.

By starting transmission of an SA by using the special SA region, it is possible for the transmission side UE to cause the user apparatus UE operating in a discontinuous reception state to receive the SA and to transition to a continuous reception state, and thus, a packet loss can be avoided. In the following, the special SA region will be further specifically described.

The special SA region may be an SA resource pool arriving at a predetermined multiple of a period at which the SA resource pools arrive, may be a specific frame/subframe, or may be a specific resource (frequency-time resource) in the SA resource pool arriving at the predetermined multiple of a period at which the SA resource pools arrive. Further, the special SA region may be associated with a D2DSS or a D2D frame number.

For example, it is possible to have an SA resource pool as a target right after the D2DSS, or to have as a target an SA resource pool that includes a frame with the smallest D2D frame number. It should be noted that the D2D frame number is a frame number for D2D. In D2D communications according to an embodiment, it is assumed that the D2D frame number (and subframe numbers in the frame) is synchronized between the transmission side UE and the reception side UE.

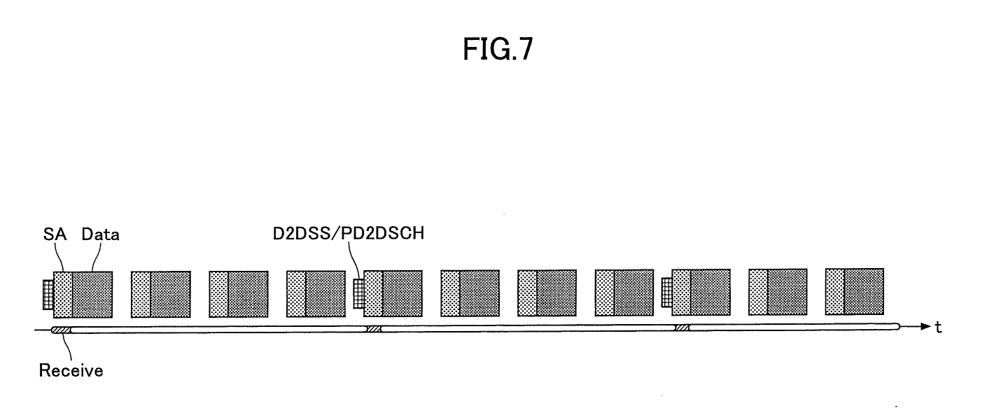

FIG. 7 illustrates an operation example of the user apparatus UE which performs discontinuous reception operation by using the special SA region. In the example of FIG. 7, an SA resource pool immediately after a D2DSS/PD2DSCH arriving at a period longer than that for SA resource pools is used as the special SA region, and the discontinuous reception operation is performed by monitoring the region.

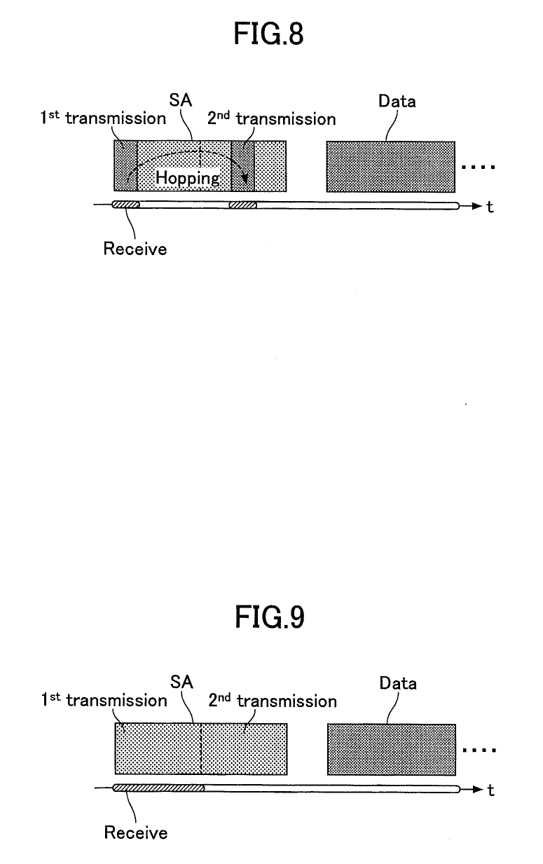

Further, examples are illustrated in FIG. 8 and FIG. 9, in which examples, the special SA region is defined as a specific subframe in an SA resource pool, which subframe includes a special SA region. In the example of FIG. 8, a specific subframe in an SA resource pool, and a subframe with which the same MAC PDU is transmitted by retransmission are defined as the special SA region. It should be noted that this example is a case where the number of retransmissions according to hopping is one, and a time hopping pattern is defined independently from the frequency resource.

In the example of FIG. 9, a resource pool (subframe) in which initial transmission in the SA resource pool is performed is defined as the special SA region. It should be noted that these examples are only examples. A resource pool (subframe) in which retransmission is performed may be defined as the special SA region. It should be noted that, in the case where retransmission is performed twice or more, a predefined one of the numbered retransmissions may be defined as the special SA region.

With respect to which resource is defined as the special SA region, a value (frame number/subframe number, a number indicating multiple of the SA period, etc.,) common to all of the user apparatuses UEs may be preset, or, the transmission side user apparatus UE may report to the reception side user apparatus UE by using a predetermined channel (e.g., PD2DSCH) or upper layer signaling. Further, in the case where the user apparatus UE is in a coverage of the base station eNB, the value indicating the special SA region may be reported from the base station eNB to the user apparatus UE via upper layer signaling (RRC signaling, SIB, etc.).

<Condition for Transmitting SA Via Special SA Region>

For example, in the case where the special SA region is uniformly set for all of the user apparatuses UEs in the same coverage, it is expected that congestion of the special SA region will occur. Therefore, the congestion of the special SA region may be avoided by setting conditions for the transmission side user apparatus UE to transmit an SA via the special SA region.

For example, it may be specified that, in the special SA region, only an SA corresponding to the head of upper layer packets (PLC PDU, MAC PDU, etc.,) can be transmitted. With the above arrangement, it is possible for a UE operating in a discontinuous reception state to receive an SA and transition to a continuous reception state in order to receive the upper layer packets from the beginning.

Further, for example, it may be specified that, in the special SA region, only unicast/groupcast transmission is allowed and broadcast transmission is not allowed.

Further, it may be specified that only an SA or data with a special format for causing the user apparatus UE in a discontinuous reception state to transition to a continuous reception state can be transmitted via the special SA region. It should be noted that, by taking into consideration a case where there exists a user apparatus UE that does not support the special SA region, the setting of the special SA region may be applied to each resource pool.

The conditions for transmitting an SA via the special SA region may be preset in the user apparatuses UEs, or the conditions may be reported to the user apparatuses UEs from the base station eNB via the upper layer signaling.

### Second Embodiment

Next, a second embodiment will be described. According to the second embodiment, wake-up signaling is introduced, which signaling is a special signaling used for switching the user apparatus UE in a discontinuous reception state to a continuous reception state. In the following, there is a case in which a signal transmitted/received by the wake-up signaling is referred to as a wake-up signal (start-up signal).

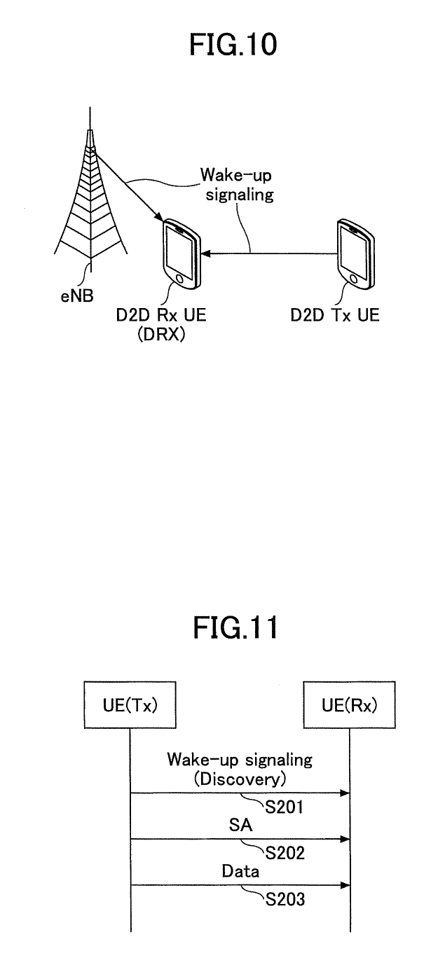

As illustrated in FIG. 10, in an embodiment, the wake-up signaling may be performed by the base station eNB for the user apparatus UE in discontinuous reception operations, or may be performed by the transmission side user apparatus UE.

The user apparatus UE in discontinuous reception operations, which has received a wake-up signal, performs switching to a continuous reception operation. In other words, by introducing the wake-up signaling, it is possible for the user apparatus UE to decrease the frequency of monitoring an SA in discontinuous reception operations (to increase the discontinuous reception period), and it is possible to provide further battery energy savings. Further, it is not necessary for the transmission side user apparatus UE to determine the discontinuous reception operation state of the reception side user apparatus UE, and it is possible to perform terminal-implemented discontinuous reception operation.

<Reporting Contents Example According to Wake-Up Signaling>

In the wake-up signal according to an embodiment, an identifier is included for indicating the user apparatus UE to be transitioned to a continuous reception state. The identifier may be, for example, an SA ID (physical layer ID included in the SA), an upper layer (e.g., MAC, PDCP, IP) destination ID, an upper layer transmission source ID, an upper layer group ID, and an identifier of the reception side user apparatus UE. The user apparatus UE in a D2D discontinuous reception state, which has received a wake-up signal including a specific identifier at a monitoring timing, transitions to a continuous reception state. Regarding which identifier should be received in the wake-up signal for transitioning to a continuous reception state, it may be preset in the user apparatus UE, or, it may be reported from the base station eNB to the user apparatus UE via RRC signaling or the like to be set in the user apparatus UE.

Further, the wake-up signal may include, in addition to the identifier described above, an identifier of a resource pool to be monitored. The user apparatus UE, which has received the resource pool identifier, monitors the specified resource pool, and transitions to a continuous reception state in the case where the reception target SA is received.

Further, for example, aside from the discontinuous reception operation, a user apparatus UE in a sleep state in which SA reception operations are not performed may be transitioned to a reception state (e.g., continuous reception state) by using the wake-up signaling.

When introducing this type of sleep state, the transition condition, used for transitioning from a continuous reception state to a discontinuous reception state as described above, may be also used as a transition condition for transitioning to a sleep state. Alternatively, a transition condition for transitioning to a sleep state may be defined separately.

Further, similar to the above-described condition for transmitting an SA in the special SA region, a condition for performing the wake-up signaling may be defined. By having such conditions as described above, it is possible to reduce signaling overhead.

For example, in the wake-up signaling, wake-up signaling may be transmitted in such a way that an SA corresponding to the head of the upper layer packets (RLC PDU, MAC PDU, etc.,) can be received. For example, in the case where wake-up signaling is performed from a transmission side UE to a reception side UE, the transmission side UE may perform wake-up signaling before transmitting upper layer packets, and, after the wake-up signaling, may perform SA transmission for the upper layer packet transmission.

A similar condition may be realized by transmitting wake-up signaling based on a transmission buffer of the transmission side UE. For example, wake-up signaling may be transmitted when the transmission buffer of the transmission side UE is increased, or it may be limited to the case where the buffer is increased from zero.

Further, for example, transmission of wake-up signaling may be permitted only for unicast/groupcast communications, and wake-up signaling may not be transmitted for broadcast communications. It should be noted that, by taking into consideration a case where there exists a user apparatus UE that does not support the wake-up signaling, it may be specified that the setting of the wake-up signaling can be applied to each resource pool.

As illustrated in FIG. 10, wake-up signaling may be transmitted to the reception side user apparatus UE from the base station eNB, or may be transmitted from the transmission side user apparatus UE.

<Wake-Up Signaling Based on Discovery>

First, a case will be described in which wake-up signaling is performed by a transmission side user apparatus UE for a reception side user apparatus UE. FIG. 11 illustrates a sequence example of this case. In the case where wake-up signaling is performed for the reception side UE from the transmission side UE, signal transmission is performed by using a discovery message (or, a message similar to the discovery message) (step 201). In other words, the wake-up signaling is performed by using a discovery resource. Next, SA transmission (step 202) and data transmission (step 203) are performed.

A discovery message for the wake-up signaling may have a format distinguishable from a discovery message used for a normal discovery. For example, a discovery message for the wake-up signaling and a normal discovery message may use different name spaces. Further, for example, different scrambling DMRS base sequences/cyclic shifts/OCCs may be applied. Alternatively, a resource pool for the wake-up signaling may be defined.

Regarding a structure of a discovery message for the wake-up signaling, an ID (identifier) may be included directly in the bit sequence of the discovery message, or the ID may be mapped into the scrambling DMRS base sequence/cyclic shift/OCC.

In the case where the ID (identifier) is included directly in the bit sequence of the message, the overhead will be increased but the reception complexity will not be increased. On the other hand, in the case where the ID is mapped into the scrambling DMRS base sequence/cyclic shift/OCC, etc., the overhead will be reduced but the reception complexity will be increased.

Further, in the case where the wake-up signaling is performed by unicast or groupcast, the reception side UE may transmit a response to the wake-up signaling to the transmission side UE by using a discovery procedure or a communication procedure. Here, in the case where the response is transmitted by using a discovery procedure, a response time window may be defined. The response time window includes, for example, the same resource pool period, the next resource pool period, etc.

<Wake-Up Signaling from Base Station eNB>

Next, a case will be described in detail in which the wake-up signaling is performed from the base station eNB.

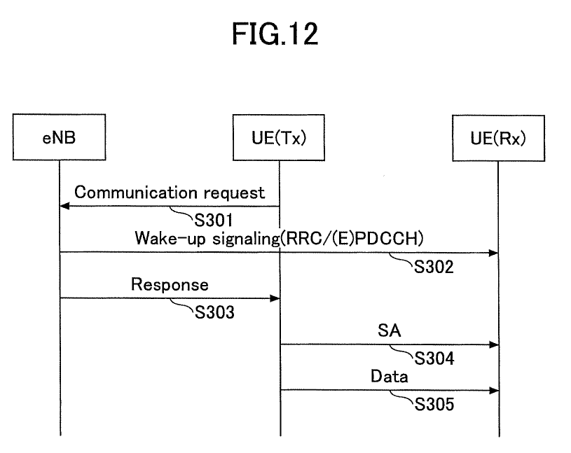

FIG. 12 illustrates a sequence example of this case. In the example of FIG. 12, in S301, the transmission side UE transmits a communication request to the base station eNB. For example, one or more IDs of the reception side UEs are included in the communication request. The communication request may be realized by a resource allocation request or a D2D buffer status report (D2D BSR), or, an independent message may be used for the communication request.

The base station eNB, which has received the communication request, transmits a wake-up signal to the reception side UE (S302). The wake-up signal may be transmitted by RRC signaling, or may be transmitted by the (E)PDCCH.

Further, the base station eNB may increase signaling reliability by transmitting a response for the communication request to the transmission side UE (S303). In this case, the transmission side UE, which has received the response, starts SA transmission (S304) and data transmission (S305).

As illustrated in S302, the wake-up signal is transmitted from the base station eNB to the reception side UE via the (E)PDCCH or via the upper layer signaling (RRC signaling including Paging). Here, in the wake-up signal, a single ID indicating a reception target may be included, or, a list of IDs (multiple IDs) may be included and the reception side UE may make a wake-up determination based on each field ID. In other words, for example, the reception side UE determines to wake-up (transition to the continuous reception state) if own ID is included.

Further, a format of the wake-up signal is not limited to a specific type. For example, a new Radio Network Temporary ID (RNTI) may be defined and used. Alternatively, a D2D RNTI may be used in the wake-up signal, and the wake-up signal may be distinguished from the D2D Mode 1 resource allocation according to the message format. The RNTI transmission subframe may be periodically defined, and it may be assumed that the user apparatus UE monitors the RNTI also in a cellular DRX state and in RRC_IDLE. Further, in order to maximize the reception target terminals, it may be assumed that the wake-up signal is monitored even by an RRC_IDLE terminal.

The base station eNB may transmit communication availability or no-availability with the reception side UE and transmit a Mode 1 resource allocation to the transmission side UE as a response to the transmission side UE that has requested the wake-up signaling transmission in S301 of FIG. 12. As an example, in the case where the base station eNB determines that the UE (or an unspecified UE), with which the transmission side UE desires to communicate, is not around the transmission side UE, the communication no-availability may be transmitted.

Further, in the case where the reception side UE illustrated in FIG. 12 is in a RRC_CONNECTED state, the reception side UE may report to the base station eNB its transition to a D2D discontinuous reception state and an identifier of monitor target during the discontinuous reception. Regarding the report, the UE may transmit a report only once when transitioning to a D2D discontinuous reception state, or, after the first report, may periodically report that the UE is in a D2D discontinuous reception state. Further, the report is performed by, for example, a MAC signal, an RRC signal, etc. As the identifier of the monitor target, an SA ID may be used, or, an ID of an upper layer destination/transmission source.

By performing the above-described report, it is possible for the base station eNB to transmit a wake-up signal to the reception side UE by using unicast.

Here, in the case where the transmission side UE requests the wake-up signaling for unicast D2D to the base station eNB and in the case where the target reception side UE does not exist in a cell or a neighbor cell, the base station eNB may switch the UE from D2D communications to cellular communications. Under the above situations, the D2D communications are not available. Therefore, by switching the UE to the cellular communications as described above, unnecessary D2D transmissions can be avoided and a fall-back to cellular communications can be realized.

It should be noted that, in the example illustrated in FIG. 12, the base station eNB, which is a wake-up signaling request destination, is the same as the base station eNB that performs wake-up signaling transmission. However, the two base stations eNBs may be different.

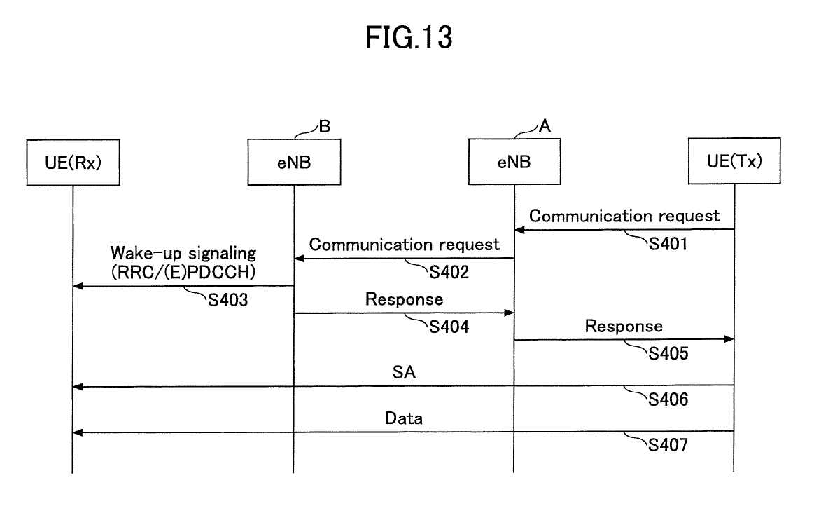

FIG. 13 illustrates a sequence example of this case. As illustrated in FIG. 13, in S401, when the transmission side UE transmits a communication request to a base station eNB-A, the communication request is transferred to a base station eNB-B (S402).

The base station eNB-B, which has received the communication request, transmits a wake-up signal to the reception side UE (S403).

On the other hand, the base station eNB-B transmits a response for the communication request to the transmission side UE via the base station eNB-A (S404, S405). The transmission side UE, which has received the response, starts SA transmission (S406) and data transmission (S407). With the above arrangement, for example, it is possible to transmit a wake-up signal to a user apparatus UE of a neighbor cell.

### Third Embodiment

As described above, in the conventional D2D communications, there is a problem in that the battery energy consumption is increased. This problem may be resolved by a method which stops wasteful transmissions. In the following, an example of this method will be described as a third embodiment.

According to the third embodiment, a response resource corresponding to an SA transmission resource is defined. It is assumed that the user apparatus UE that has received the SA and/or “data accompanying the SA” (hereinafter, referred to as SA/Data) returns a response by using the response resource. Further, in the case where there is no response for a predetermined number of SA/Data transmissions, the transmission side UE stops the transmission.

It should be noted that the number of transmissions before stopping the transmission may be reported to the user apparatus UE from the base station eNB by using an upper layer (MAC, RRC, etc.,), or, may be preset in the user apparatus UE.

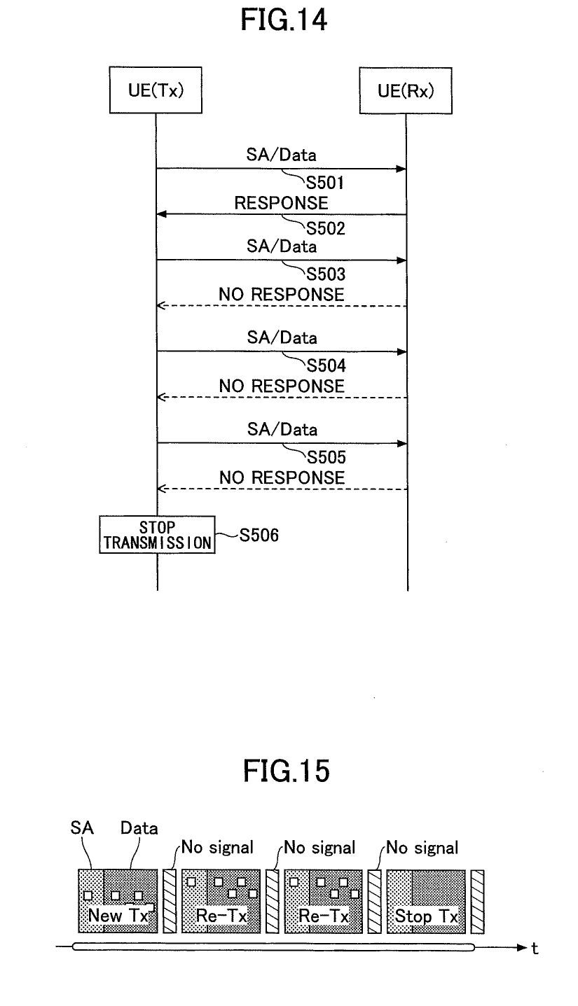

For example, as illustrated in FIG. 14, the transmission side UE transmits SA/Data (S501) and receives a response from the reception side UE (S502). After the transmission of SA/Data at S503, the transmission side UE does not receive a response and stops transmission at S506.

FIG. 15 illustrates an operation example 1 of the transmission side UE. As illustrated in FIG. 15, as an example, a response resource is defined in a subframe between the Data and the following SA. The transmission side UE newly starts SA/Data transmission. The SA/Data transmission is repeated for three times including the first transmission. However a response is not received in the response resource (No signal). As a result, the SA/Data transmission is stopped (Stop Tx). It should be noted that, after stopping the transmission, the transmission may be resumed, for example, after a predetermined time or upon receiving another trigger.

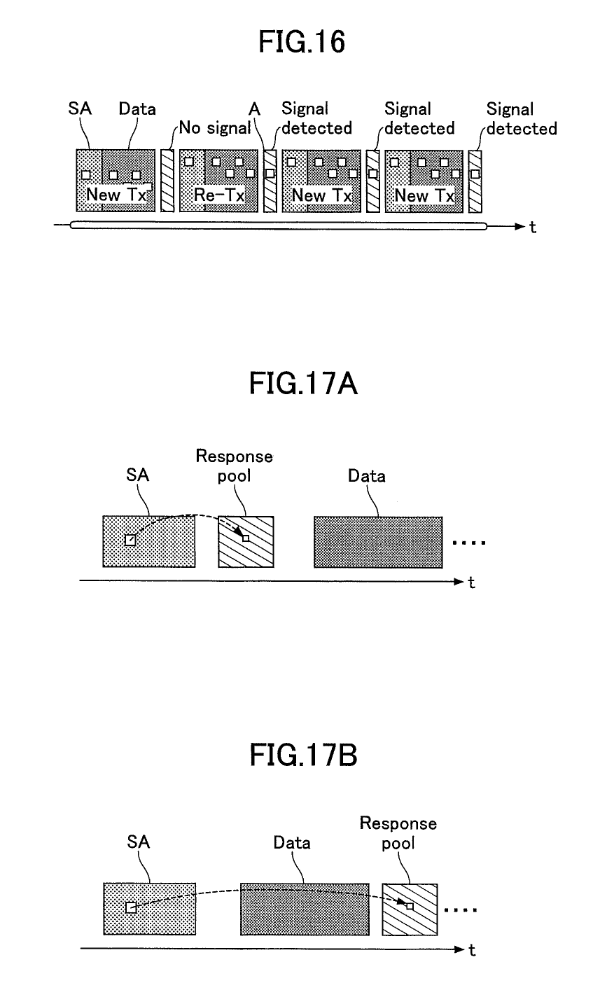

FIG. 16 illustrates an operation example 2 of the transmission side UE. In the example of FIG. 16, in a response resource indicated by A in the figure, the transmission side UE receives a NACK from the reception side UE. At this time, it is possible for the transmission side UE to perform retransmission by performing, for example, link adaptation (e.g., MCS change).

As a more specific example, the reception side UE may transmit a DM-RS sequence, a PUSCH, etc., in the response resource, and the transmission side UE may determine whether the listener (reception side UE) exists or not by power detection of the resource. Further, the response transmission side UE may transmit sequences by dividing the sequences according to an ACK/NACK, and the response reception side UE may determine existence of an ACK/NACK according to the received sequence. Alternatively, transmission time-frequency resources may be changed according to an ACK/NACK. It should be noted that, in the case of unicast, an ACK/NACK may be transmitted by using a PUSCH base format.

A method of response resource arrangement is not limited to a particular method. For example, as illustrated in FIG. 17A, the response resource may be arranged between an SA and Data accompanying the SA, or, as illustrated in FIG. 173, the response resource may be arranged between the Data and the following SA.

In an arrangement example illustrated in FIG. 17A, Data transmission can be controlled based on the response to the SA. On the other hand, in an arrangement example illustrated in FIG. 17B, it is possible to transmit a response which includes a response to be transmitted via the response resource and an ACK/NACK response to the Data.

### Apparatus Configuration Example

In the following, configuration examples of a user apparatus UE and a base station eNB which perform operations according to an embodiment of the present invention (first embodiment, second embodiment, third embodiment) will be described. It should be noted that, in the following, configurations of the user apparatus UE are separately described according to the three embodiments. However, any two or all of the embodiments may be combined.

<Configuration Example of User Apparatus UE>

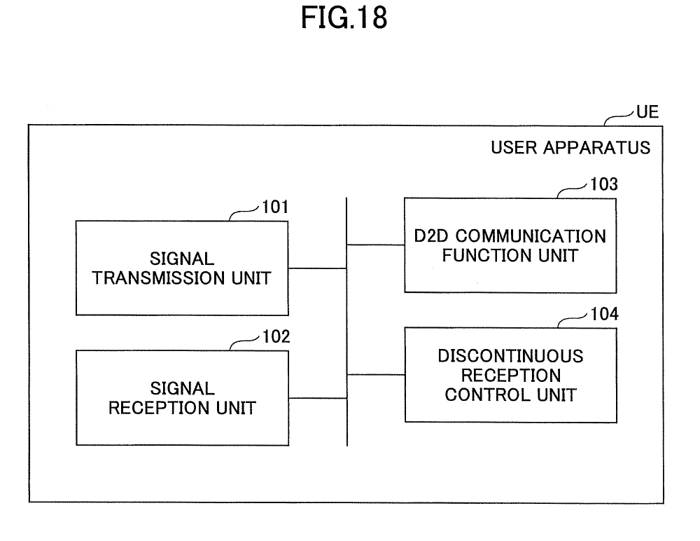

FIG. 18 illustrates a functional structure diagram of the user apparatus UE according to an embodiment. An example illustrated in FIG. 18 is a structure according to the first embodiment. As illustrated in FIG. 18, the user apparatus UE includes a signal transmission unit 101, a signal reception unit 102, a D2D communication function unit 103, and a discontinuous reception control unit 104. It should be noted that FIG. 18 illustrates functional units of the user apparatus UE especially related to an embodiment only, and thus, the user apparatus UE further includes at least functions for performing operations according to LTE (not shown in the figure). Further, a functional structure illustrated in FIG. 18 is merely an example. Functional classification and names of functional units may be anything as long as operations related to an embodiment can be performed.

The signal transmission unit 101 includes a function for wirelessly transmitting various kinds of physical layer signals generated from an upper layer signal which should be transmitted from the user apparatus UE. Further, the signal transmission unit 101 have a transmission function of D2D communications and a transmission function of cellular communications.

The signal reception unit 102 includes a function for wirelessly receiving various kinds of signals from another user apparatus UE or the base station eNB, and obtaining upper layer signals from the received physical layer signals. The signal reception unit 102 have a reception function of D2D communications and a reception function of cellular communications.

The D2D communication function unit 103 has functions of D2D applications, and performs resource allocation and transmission-reception control of a discovery signal, and resource allocation and transmission-reception control of SA/Data.

The discontinuous reception control unit 104 is a function unit for performing discontinuous reception operations according to the first embodiment. For example, the discontinuous reception control unit 104 has a function for putting the user apparatus UE in a discontinuous reception state in the case where a predetermined time elapses from the time when an SA has been last received, and for causing the user apparatus UE to transition from a discontinuous reception state to a continuous reception state in the case where an SA is received in a discontinuous reception state. The discontinuous reception control unit 104 has information of a special SA region, and is capable of performing transmission and reception by using the special SA region as described in the first embodiment.

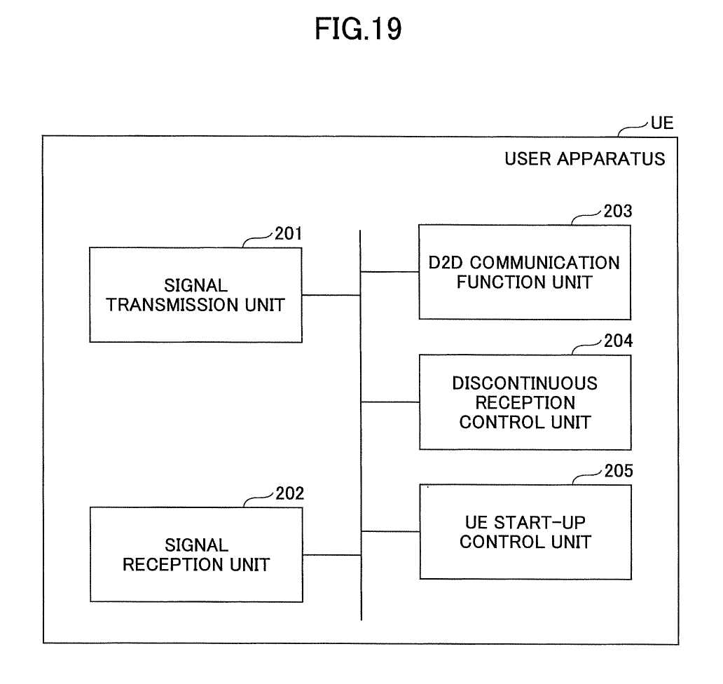

FIG. 19 illustrates another functional structure diagram of the user apparatus UE according to an embodiment. An example illustrated in FIG. 19 is a structure in which processing according to the second embodiment is performed in addition to processing according to the first embodiment. As illustrated in FIG. 19, the user apparatus UE includes a signal transmission unit 201, a signal reception unit 202, a D2D communication function unit 203, a discontinuous reception control unit 204, and UE start-up control unit 205. It should be noted that FIG. 19 illustrates functional units of the user apparatus UE especially related to an embodiment only, and thus, the user apparatus UE further includes at least functions for performing operations according to LTE (not shown in the figure). Further, a functional structure illustrated in FIG. 19 is merely an example. Functional classification and names of functional units may be anything as long as operations related to an embodiment can be performed.

The signal transmission unit 201, the signal reception unit 202, the D2D communication function unit 203, and the discontinuous reception control unit 204 have similar functions as the signal transmission unit 101, the signal reception unit 102, the D2D communication function unit 103, and the discontinuous reception control unit 104, respectively, as described while making reference to FIG. 18.

The UE start-up control unit 205 is a function unit for performing operations related to the wake-up signal described in the second embodiment. The UE start-up control unit 205 causes the own UE to transition to a continuous reception state in the case where the wake-up signal is received from another UE or the base station eNB when the own UE is in a discontinuous reception state (or in a sleep state). Further, the UE start-up control unit 205 also has a function for transmitting a wake-up signal to another UE based on the discovery message.

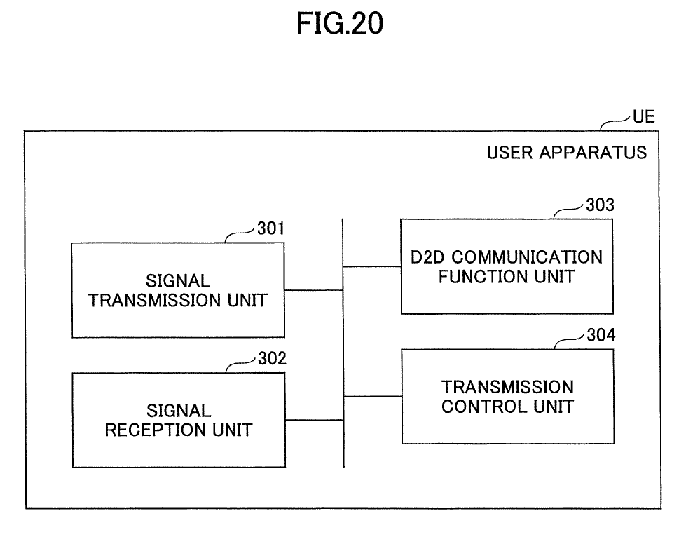

FIG. 20 illustrates yet another functional structure diagram of the user apparatus UE according to an embodiment. An example illustrated in FIG. 20 is a structure according to the third embodiment. As illustrated in FIG. 20, the user apparatus UE includes a signal transmission unit 301, a signal reception unit 302, a D2D communication function unit 303, and a transmission control unit 304. It should be noted that FIG. 20 illustrates functional units of the user apparatus UE especially related to an embodiment only, and thus, the user apparatus UE further includes at least functions for performing operations according to LTE (not shown in the figure). Further, a functional structure illustrated in FIG. 20 is merely an example. Functional classification and names of functional units may be anything as long as operations related to an embodiment can be performed.

The signal transmission unit 301, the signal reception unit 302, and the D2D communication function unit 303 have similar functions as the signal transmission unit 101, the signal reception unit 102, and the D2D communication function unit 103, respectively, as described while making reference to FIG. 18. It should be noted, however, that the D2D communication function unit 303 has information of a response resource corresponding to an SA transmission resource as described in the third embodiment, and the D2D communication function unit 303 includes a function for controlling the signal transmission unit 301 to return a response (which may include an ACK/NACK) by using the response resource.

After transmitting an SA, the transmission control unit 304 monitors a response received by the signal reception unit 302 via the response resource, and stops the SA transmission in the case where no response is received for a predetermined number of times. In other words, after transmitting a predetermined D2D signal from the signal transmission unit 301 by using a predetermined resource, the transmission control unit 304 monitors a response resource corresponding to the predetermined resource by using the signal reception unit 302, checks whether the response is received, and stops transmission of the predetermined D2D signal in the case where the response is not received continuously for a predetermined number of times in spite of transmitting the predetermined D2D signal for the predetermined number of times.

<Configuration Example of Base Station eNB>

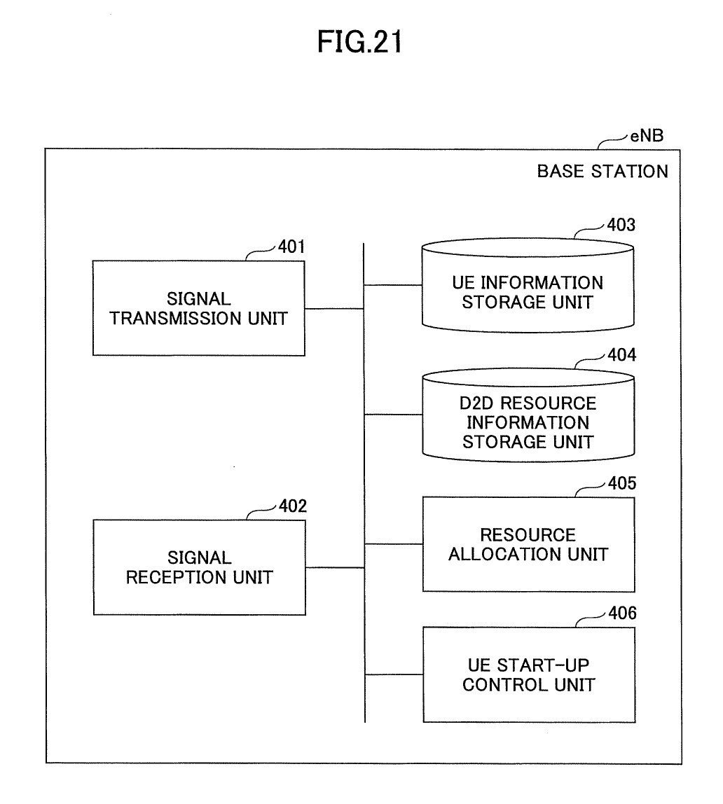

FIG. 21 illustrates a functional structure diagram of the base station eNB according to an embodiment. The base station eNB illustrated in FIG. 21 includes a function for performing the wake-up signal transmission according to the second embodiment. However, the base station eNB may be used in other embodiments.

As illustrated in FIG. 21, the base station eNB includes a signal transmission unit 401, a signal reception unit 402, a UE information storage unit 403, a D2D resource information storage unit 404, a resource allocation unit 405, and a UE start-up control unit 406. It should be noted that FIG. 21 illustrates functional units of the base station eNB especially related to an embodiment only, and thus, the base station eNB further includes at least functions for performing operations according to LTE (not shown in the figure). Further, a functional structure illustrated in FIG. 21 is merely an example. Functional classification and names of functional units may be anything as long as operations related to an embodiment can be performed. It should be noted that a function is included for performing D2D resource allocation in FIG. 21. However, when applying to the second embodiment, it may be also possible not to include a function for performing the D2D resource allocation.

The signal transmission unit 401 includes a function for wirelessly transmitting various kinds of physical layer signals generated from an upper layer signal which should be transmitted from the base station eNB. The signal reception unit 402 includes a function for wirelessly receiving various kinds of signals from the user apparatuses UEs, and obtaining upper layer signals from the received physical layer signals.

UE capability information received from each UE is stored in the UE information storage unit 403. Information indicating a D2D resource allocated for each UE is stored in the D2D resource information storage unit 404. Further, the allocation information is removed in the case where the resource is released. The resource allocation unit 405 performs allocation of D2D resources (resource pools, individual resources, etc.,) according to a resource allocation situation for each UE by referring to the UE information storage unit 403 and the D2D resource information storage unit 404.

In the second embodiment, the UE start-up control unit 406 performs transmission-reception control of a signal related to the wake-up signaling performed by the base station eNB. For example, the UE start-up control unit 406 also includes a function for controlling UEs to switch to cellular communications and a function for transferring a communication request to another base station eNB.

As described above, according to an embodiment, a user apparatus is provided. The user apparatus is used in a mobile communication system that supports D2D communications. The user apparatus includes a control unit configured to put the user apparatus in a discontinuous reception state in the case where a predetermined time elapses after the time when a predetermined D2D signal has been last received, and a reception unit configured to monitor D2D resources arriving at a predetermined period in a discontinuous reception state. With the above arrangement, in D2D communications, it is possible for the user apparatus to perform discontinuous reception operations appropriately, and battery energy consumption can be reduced.

In a discontinuous reception state, in the case where the predetermined D2D signal is received by the reception unit, the control unit may cause the user apparatus to transition from a discontinuous reception state to a continuous reception state. With the above arrangement, in D2D communications, it is possible to transition from a discontinuous reception state to a continuous reception state appropriately.

The predetermined D2D signal is, for example, a scheduling assignment signal. The D2D resources arriving at the predetermined period are all or a part of SA resource pools arriving at a predetermined multiple of a period of the SA resource pools allocated for the scheduling assignment signal. With the above arrangement, it is possible to perform discontinuous reception operations appropriately for SAs which are transmitted very frequently, and the battery energy consumption can be reduced significantly.

The D2D resources arriving at the predetermined period may be special resources commonly determined between the user apparatus and the transmission side apparatus. With the above arrangement, it is possible for the transmission side user apparatus to start transmission from the special resources, and thus, it is possible for the reception side discontinuous-reception-performing user apparatus to perform reception without packet loss (without increasing delay).

Only the predetermined D2D signal that includes specific information may be transmitted from the transmission side apparatus via the special resources. With the above arrangement, traffic congestion in the special resources can be avoided.

In the case where the user apparatus is in a discontinuous reception state, the control unit may cause the user apparatus to transition from a discontinuous reception state to a continuous reception state in the case where a predetermined start-up signal is received by the reception unit. With the above arrangement, it is possible to make a discontinuous reception period longer, and it is possible to increase effects of saving the battery energy consumption significantly.

The reception unit may receive as the predetermined start-up signal a discovery signal from another user apparatus. It is possible to introduce a predetermined start-up signal smoothly by using a discovery signal.

Further, in the mobile communication system according to an embodiment, a base station is provided. The base station communicates with the user apparatus, and includes a transmission unit configured to transmit a predetermined start-up signal to the user apparatus. With the above arrangement, it is also possible to make the discontinuous reception period longer, and it is possible to increase effects of saving the battery energy consumption significantly.

The base station may transmit the predetermined start-up signal in response to receiving a request for transmitting a predetermined start-up signal from a transmission side user apparatus corresponding to the reception side user apparatus. With the above arrangement, it is possible for the transmission side user apparatus to transmit a request to the base station in the case where the user apparatus intends to perform D2D transmission to another user apparatus.

The user apparatus UE according to an embodiment may include a CPU and a memory, may be realized by having a program executed by the CPU, may be realized by hardware such as hardware circuitry or the like in which the logic described in an embodiment is included, or may be realized by a mixture of a program and hardware.

The base station eNB according to an embodiment may include a CPU and a memory, may be realized by having a program executed by the CPU (processor), may be realized by hardware such as hardware circuitry or the like in which the logic described in an embodiment is included, or may be realized by a mixture of a program and hardware.

As described above, embodiments have been described. The disclosed invention is not limited to these embodiments, and a person skilled in the art would understand various variations, modifications, replacements, or the like. Specific examples of numerical values have been used for encouraging understanding of the present invention. These numeric values are merely examples and, unless otherwise noted, any appropriate values may be used. In the above description, partitioning of items is not essential to the present invention. Matters described in more than two items may be combined if necessary. Matters described in one item may be applied to matters described in another item (as long as they do not conflict). In a functional block diagram, boundaries of functional units or processing units do not necessarily correspond to physical boundaries of parts. Operations of multiple functional units may be physically performed in a single part, or operations of a single functional unit may be physically performed by multiple parts. For the sake of description convenience, the base station eNB and the user apparatus UE have been described by using functional block diagrams. These apparatuses may be implemented by hardware, by software, or by combination of both. Each of the software which is executed by a processor included in the base station eNB according to an embodiment and the software which is executed by a processor included in the user apparatus UE according to an embodiment may be stored in a random access memory (RAM), a flash memory, a read-only memory (ROM), an EPROM, an EEPROM, a register, a hard disk drive (HDD), a removable disk, a CD-ROM, a database, a server, or any other appropriate recording medium.

The present invention is not limited to the above embodiments and various variations, modifications, alternatives, replacements, etc., may be included in the present invention without departing from the spirit of the invention.

The present application is based on and claims the benefit of priority of Japanese Priority Application No. 2014-213221 filed on Oct. 17, 2014, the entire contents of which are hereby incorporated by reference.

### DESCRIPTION OF THE REFERENCE NUMERALS

eNB Base station
UE User apparatus
101 Signal transmission unit
102 Signal reception unit
103 D2D communication function unit
104 discontinuous reception control unit
201 Signal transmission unit
202 Signal reception unit
203 D2D communication function unit
204 discontinuous reception control unit
205 UE start-up control unit
301 Signal transmission unit
302 Signal reception unit
303 D2D communication function unit
304 Transmission control unit
401 Signal transmission unit
402 Signal reception unit
403 UE information storage unit
404 D2D resource information storage unit
405 Resource assignment unit
406 UE start-up control unit

1. A user apparatus used in a mobile communication system supporting Device-to-Device (D2D) communications, the user apparatus comprising:
a control unit configured to put the user apparatus in a discontinuous reception state in the case where predetermined time elapses after a predetermined D2D signal has been last received; and
a reception unit configured to monitor a D2D resource arriving at a predetermined period in the discontinuous reception state.

2. The user apparatus according to claim 1, wherein, in the discontinuous reception state, the control unit causes the user apparatus to transition from the discontinuous reception state to a continuous reception state in the case where the predetermined D2D signal is received by the reception unit.

3. The user apparatus according to claim 1, wherein the predetermined D2D signal is a scheduling assignment (SA) signal, and the D2D resource arriving at the predetermined period is all or a part of second SA resource pools, of first SA resource pools, arriving at a predetermined multiple of a period of the first SA resource pools allocated for the SA signal.

4. The user apparatus according to claim 1, wherein the D2D resources arriving at the predetermined period are special resources commonly determined between the user apparatus and a transmission side apparatus.

5. The user apparatus according to claim 4, wherein only the predetermined D2D signal that includes specific information is transmitted from the transmission side apparatus via the special resources.

6. The user apparatus according to claim 1, wherein, in the case where the user apparatus is in the discontinuous reception state, the control unit causes the user apparatus to transition from the discontinuous reception state to a continuous reception state in the case where a predetermined start-up signal is received by the reception unit.

7. The user apparatus according to claim 6, wherein the reception unit receives as the predetermined start-up signal a discovery signal from another user apparatus.

8. A base station for performing communications with the user apparatus according to claim 6 in the mobile communication system, the base station comprising:
a transmission unit configured to transmit the predetermined start-up signal to the user apparatus.

9. The base station according to claim 8, wherein the base station transmits the predetermined start-up signal in response to receiving a request for transmitting the predetermined start-up signal from a transmission side user apparatus for the user apparatus.

10. A discontinuous reception method performed by a user apparatus used in a mobile communication system supporting Device-to-Device (D2D) communications, the discontinuous reception method comprising:
putting the user apparatus in a discontinuous reception state in the case where predetermined time elapses after a predetermined D2D signal has been last received; and
monitoring a D2D resource arriving at a predetermined period in the discontinuous reception state.

11. The user apparatus according to claim 2 wherein the predetermined D2D signal is a scheduling assignment (SA) signal, and the D2D resource arriving at the predetermined period is all or a part of second SA resource pools, of first SA resource pools, arriving at a predetermined multiple of a period of the first SA resource pools allocated for the SA signal.

12. The user apparatus according to claim 2, wherein the D2D resources arriving at the predetermined period are special resources commonly determined between the user apparatus and a transmission side apparatus.

13. The user apparatus according to claim 2, wherein, in the case where the user apparatus is in the discontinuous reception state, the control unit causes the user apparatus to transition from the discontinuous reception state to a continuous reception state in the case where a predetermined start-up signal is received by the reception unit.

14. The user apparatus according to claim 3, wherein the D2D resources arriving at the predetermined period are special resources commonly determined between the user apparatus and a transmission side apparatus.

15. The user apparatus according to claim 3, wherein, in the case where the user apparatus is in the discontinuous reception state, the control unit causes the user apparatus to transition from the discontinuous reception state to a continuous reception state in the case where a predetermined start-up signal is received by the reception unit.

16. The user apparatus according to claim 4, wherein, in the case where the user apparatus is in the discontinuous reception state, the control unit causes the user apparatus to transition from the discontinuous reception state to a continuous reception state in the case where a predetermined start-up signal is received by the reception unit.

17. The user apparatus according to claim 5, wherein, in the case where the user apparatus is in the discontinuous reception state, the control unit causes the user apparatus to transition from the discontinuous reception state to a continuous reception state in the case where a predetermined start-up signal is received by the reception unit.
